(19) United States
(12) Patent Application Publication
(10) Pub. No.: US 2001/0034153 A1
(43) Pub. Date: Oct. 25, 2001

(54) Connector

(76) Inventors: Murray J. Mclntosh, Inverurie (GB); Allan Glennie, Stonehave (GB)

Correspondence Address: Warren B. Kice, Suite 3100, 901 Main Street, Dallas, TX, 75202-3789, US

(21) Appl. No.: 09/797,016

(22) Filed: Mar. 1, 2001

(30) Foreign Application Priority Data
Mar. 2, 2000 (GB) 0005013.8

(51) Int. Cl. H01R 13/627

(52) U.S. Cl. 439/364

(57) ABSTRACT

A connector for joining conduits and having a locking device to secure two parts of the connector together. The locking device is recessed in one of the parts of the connector.

### CROSS-REFERENCE TO RELATED APPLICATIONS

This application claims priority under United Kingdom Patent Application No. 0005013.8 filed on Mar. 2, 2000.

### BACKGROUND

1. Field of the Invention

This invention relates to a connector and particularly to a type of connector commonly called a stab connector for connecting hydraulic and/or electrical conduits (or others), and is typically used in subsea structures for connecting e.g. a manifold to a control conduit leading to some other undersea structure or to a control center on a rig, ROV or other control means.

2. Description of Prior Art

Existing stab connectors commonly comprise first and second portions each having mating connector terminals for individual hydraulic or electrical lines, each connector portion having a body and some form of fixing device to secure the two portions together when they are connected.

### SUMMARY

According to the present invention there is provided a connector comprising a first portion and a second portion, the first and second portions being adapted to receive and connect respective conduits in order to connect a conduit associated with the first portion to a conduit associated with the second portion, the first and second portions having a fixing device to hold the first and second portions together, wherein at least a portion of the fixing device is recessed within the first or the second portion.

### BRIEF DESCRIPTION OF THE DRAWINGS

An embodiment of the present invention will now be described by way of example and with reference to the drawings in which:

FIG. 1 is a side sectional view of a first portion of a connector according to an embodiment of the present invention;

FIG. 2 is a sectional view through the line A-A of FIG. 1;

FIG. 3 is an end view of the FIG. 1 portion from the arrow B;

FIG. 4 is a side sectional view of a second portion of the connector of FIGS. 1-3; and

FIG. 5 is an end view of the FIG. 4 second portion from the arrow C.

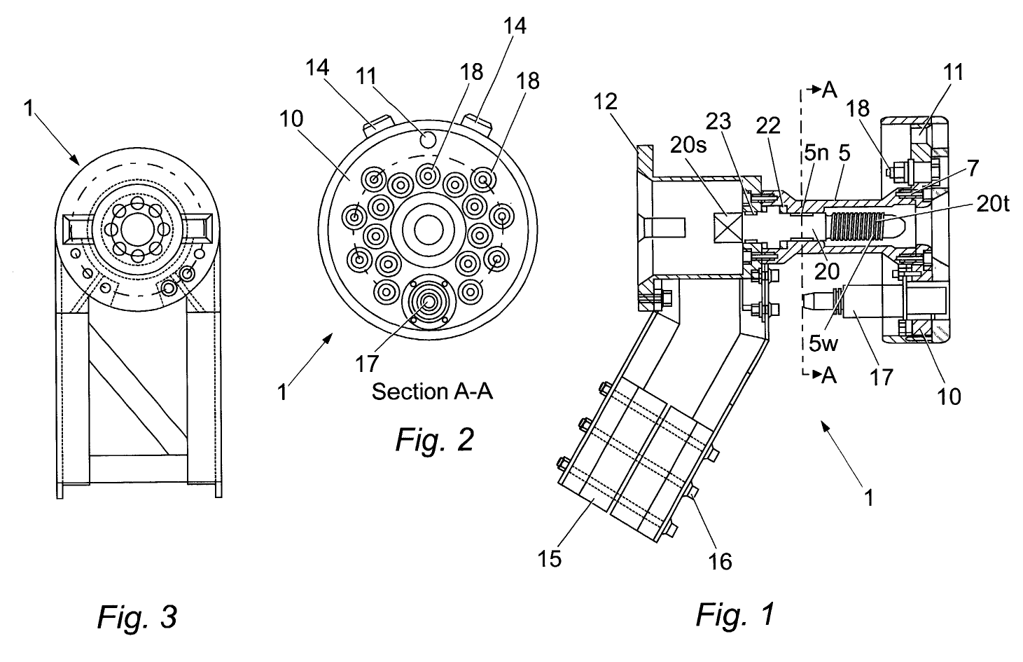

### DESCRIPTION OF THE PREFERRED EMBODIMENTS

Referring now to the drawings, a first portion 1 of a connector for connecting control lines to a subsea manifold (not shown) has a body 5, a mating plate 10 having terminal connector halves for the control lines and an ROV interface bracket 12 for connection to an ROV. The bracket 12 is fastened by screws 6 to one end of the body 5 and the plate 10 is fastened by screws 7 to the other end of the body 5. The portion 1 also has an optional clamp 15 for holding a bundle of hydraulic hoses and electrical conduits etc. (not shown) extending from a control centre at a remote location. The hoses extend through the clamp and are held by bolts 16 in the known manner before being connected to the terminal connector halves 17, 18 etc. in plate 10. Alternatively, the hoses etc. can be routed through or attached to a central rigid pipe (not shown) before being attached to the connector halves on the plate 10. The body 5 has a hollow bore in which a shaft 20 is held captive. The shaft 20 is mounted on bearings 22, 23 that permit its rotation in the bore of the body but axial movement of the shaft 20 is restricted by the bracket 12 and by a neck portion 5n of the bore of the body 5. The shaft extends through the neck 5n into a wider part of the bore 5w but does not extend beyond the end of the plate 10 fastened to the opposite end of the body 5 from the bracket 12. The shaft 20 is thus recessed in the bore of the body 5.

The shaft has a thread 20t on its outer surface in the region of the wide part of the bore 5w. At its opposite end from the plate 10, the shaft 20 extends into the bracket 12 and presents a torque shoulder 20s for a torque tool on an ROV to engage and apply torque to the shaft in order to rotate it relative to the body 5.

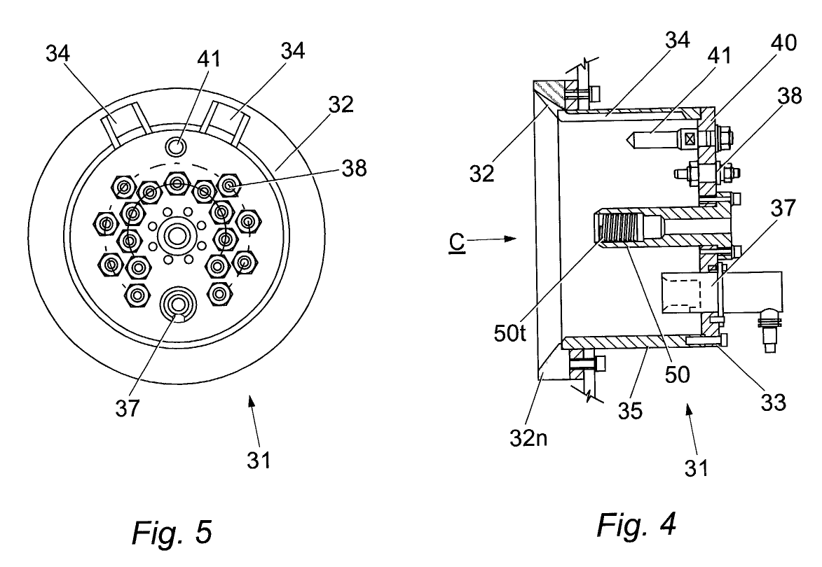

The second portion 31 of the connector shown in FIGS. 4 and 5 has a body 35 with a central hollow bore capable of receiving the first portion 1, a front face 32 to mate with the first portion on initial making up of the connector, a back plate 40 having connector halves 37, 38 to mate with the connector halves 17, 18 on the first connector, and a socket 50 to receive the shaft 20. The back plate 40 is fixed to the body 35 via screws 33, and the front face 32 has a tapered neck portion 32n attached thereto via screws 34 and opening outwards of the body 35.

The socket 50 has an internal thread 50t on an inner portion thereof that cooperates with the thread 20t on the outer surface of the shaft 20. The back plate 40 has guide pins 41 extending from the back plate 40 into the bore of the body 35, for a co-operation with sockets 11 on the first portion 1. The body 35 of the second portion 31 also has guide slots 34 that co-operate with guide pins 14 on the outer surface of the first portion 1.

In use, the first portion 1 is attached to an ROV via the bracket 12. The ROV engages a torque tool such as a spanner with the torque shoulder 20s of the shaft for turning the shaft on its axis when the connector is being made up. The first portion 1 is offered up to the second portion so that the tapered neck portion 32n of the front face 32 guides the first portion 1 into the bore of the body 35 of the second portion. The guide pins 14 co-operate with the guide slots 34 to ensure that the correct angular relationship is maintained between the two portions and that the correct connector halves are aligned in the made-up connector, and the pin(s) 41 engage in the socket(s) 11 to assist in final alignment of the two portions 1, 31.

When the first portion has moved into the body 35 of the second portion 31 in the correct alignment, the shaft 20 engages in the socket 50 and the shaft can be rotated in the socket 50 to screw the shaft 20 and socket 50 together by means of the threads 20t, 50t. The two portions can therefore be held together by the fixing device comprising the shaft 20 and socket 50 without having exposed fixing device that can be damaged as the connector is being made up.

When the shaft 20 and socket 50 are fully screwed together the connector portions 17, 37 and 18, 38 etc. mate and the connection is made up between the conduits associated with the first portion and those associated with the second portion.

Modifications and improvements can be incorporated without departing from the scope of the invention.

What is claimed is:

1. A connector comprising a first portion and a second portion, the first and second portions being adapted to receive and connect respective conduits in order to connect a conduit associated with the first portion to a conduit associated with the second portion, the first and second portions having a fixing device to hold the first and second portions together, wherein at least a portion of the fixing device is recessed within the first or the second portion.

2. A connector as claimed in claim 1, wherein the fixing device is entirely recessed in one of the first and second portions.

3. A connector as claimed in claim 1, wherein the fixing device comprises a shaft recessed in the first portion and a shaft-receiving socket recessed in the second portion.

4. A connector as claimed in claim 3, wherein the shaft and socket are adapted to be secured together.

5. A connector as claimed in claim 3, wherein co-operating screw threads are provided on the shaft and socket.

6. A connector as claimed in claim 3, wherein one of the shaft and the socket is movable relative to the other within its connector portion.

7. A connector as claimed in claim 6, wherein one of the shaft and the socket is provided with bearings to facilitate movement relative to its connector portion.

8. A connector as claimed in claim 3, wherein one of the shaft and the socket is sealed to its connector portion.

9. A connector as claimed in claim 1, wherein the first portion is a subsea free hub and the second portion is a fixed hub on a subsea installation.

10. A connector as claimed in claim 1, having a guidance mechanism to assist in the initial make-up of the connector.

11. A connector as claimed in claim 10, wherein the guidance mechanism comprises mating faces of the connector portions with tapered wedge members adapted to guide the two portions together.

12. A connector as claimed in claim 10 wherein the guidance mechanism comprises receptacles and co-operating probes.

13. A connector as claimed in claim 1, having resilient members in order to combat damage to the portions of fixing device upon making up the connector portions.
